(19) United States
(12) Patent Application Publication
(10) Pub. No.: US 2021/0178202 A1
(43) Pub. Date: Jun. 17, 2021

(54) FORCE DAMPING SYSTEM INCLUDING A FORCE DAMPER, A TEAR-AWAY LANYARD, AND A FORCE ABSORBING HARNESS

(71) Applicant: On Top Safety, Inc., Cheektowaga, NY (US)

(72) Inventors: John J. CARROCCIA, Orchard Park, NY (US); Jeffrey L. Murray, Hamburg, NY (US)

(21) Appl. No.: 17/185,071

(22) Filed: Feb. 25, 2021

Related U.S. Application Data
(63) Continuation-in-part of application No. 16/784,939, filed on Feb. 7, 2020.
Application No. 16/784,939 is a continuation-in-part of application No. 16/113,618, filed on Aug. 27, 2018.
(60) Provisional application No. 62/610,786, filed on Dec. 27, 2017.

(51) Int. Cl. A62B 35/00

(52) U.S. Cl. CPC A62B 35/0037; A62B 35/0018

(57) ABSTRACT

A force damping system progressively arrests a force imparted by an object generally includes a force damper member, a tear-away lanyard, and a force absorbing harness. The force damper member includes a compression member and a sacrificially elongatable member. The compression member is elastically deformable and compressible when the force is imparted, and the sacrificially elongatable member is plastically deformable and elongatable when the force is imparted. The tear-away lanyard includes a first terminal end and a second terminal end and at least a pair of sacrificial tear-away regions disposed between the first and second terminal ends. The force absorbing harness includes a harness connection member capable of connecting at least one of the first terminal or second terminal end of the tear-away lanyard, the harness connection member includes a sacrificial member that is plastically deformable when the force is imparted.

### CROSS-REFERENCE TO RELATED APPLICATIONS

This application is a continuation-in-part of U.S. patent application Ser. No. 16/784,939, filed Feb. 7, 2020, which application is a continuation-in-part of U.S. patent application Ser. No. 16/113,618, filed Aug. 27, 2018, which application claims the benefit under 35 U.S.C. § 119(e) of United States Provisional Patent Application No. 62/610,786, filed Dec. 27, 2017, each of which applications are incorporated herein by reference in their entireties.

### FIELD

The instant disclosure broadly relates to a force damping system including a force damper, a tear-away lanyard, and a force absorbing harness, and more specifically to a force damping system configured to serve as a fall mitigation device for an object, and even more specifically to a force damping system wherein one or more components of the system includes one or more sacrificial elements that can serve to prevent the reuse of the one or more components after being subject to a sufficient force as may occur, for example, due to a falling object or person.

### BACKGROUND

Fall prevention devices are known. For example, one such device includes a stretchable shock absorbing lanyard, e.g., Model No. 1340101 PRO™ Stretch Shock Absorbing Lanyard manufactured by Protecta®. In such device, an inner core of the device is configured to extend from about four and a half feet to about six feet while absorbing energy of a falling object. Although this device may be suitable in some situations, it cannot ensure safety in situations where the falling height is similar to the height of the object falling, e.g., a worker that is six feet falling off an elevated level of seven feet. Additionally, such type of device may be reused over and over again.

However, regulations and/or a desire to ensure worker safety has created a need for fall arrest devices that cannot be used more than a single time as the integrity of a previously used force damping system is suspect. For example, a force damping device including a resilient compression spring member used to slow the fall of a three hundred pound object a first time may not perform as effectively to slow the fall of the three hundred pound object a second time. Likewise, a force damping device including, for example, a resilient lanyard used to slow the fall of an object a first time may also not be as effective a second time. Thus, there is a long-felt need for a force damping device and/or systems including one or more components that are easy to operate, inexpensive to build, safe for their intended uses, and which can preclude the subsequent reuse of such one or more components after having been subject to a sufficient force, e.g., a force resulting from a falling object or person.

### SUMMARY

At the outset it should be understood that while the following disclosure, figures, and/or claims, etc. describe subject matter including one or more aspects described as either alone or in combination with one or more other aspects, the subject matter of the instant disclosure is not intended to be so limited. That is, the instant disclosure, figures, and claims are intended to encompass the various aspects described herein, either alone or in one or more combinations with one another. For example, while the instant disclosure may describe and illustrate a first aspect, a second aspect, and a third aspect in a manner such that the first aspect is only specifically described and illustrated relative to the second aspect, or the second aspect is only described and illustrated relative to the third aspect, the instant disclosure and illustrations are not intended to be so limiting and may encompass the first aspect alone, the second aspect alone, the third aspect alone, or one or more combinations of the first, second, and/or third aspects, e.g., the first aspect and the second aspect, the first aspect and the third aspect, the second and third aspect, or the first, second and third aspects.

The present disclosure is related to a force damping system arranged to progressively arrest a first force imparted by an object moving in a first direction, the force damping system can include at least a force damper member, a tear-away lanyard, and a force absorbing harness, wherein one or more of the force damper member, the tear-away lanyard, and the force absorbing harness can include one or more sacrificial elements that, for example, can prevent reuse of the one or more of the force damper member, the tear-away lanyard, and/or the force absorbing harness after exposure to a sufficient force, e.g., a falling object or person.

In some aspects, a force damping system in accordance with the instant disclosure can include a force damper member having a compression member and a sacrificially elongatable member, the compression member being elastically deformable and compressible when a first force is imparted and the sacrificially elongatable member being plastically deformable and elongatable when a first force is imparted.

In some aspects, a force damping system in accordance with the instant disclosure can include a tear-away lanyard having a first terminal end and a second terminal end and at least a pair of sacrificial tear-away regions disposed between the first terminal end and the second terminal.

In some aspects, a force damping system in accordance with the instant disclosure can include a force absorbing harness having a harness connection member capable of connecting at least one of the first terminal end or the second terminal end of the tear-away lanyard, and in some aspects the harness connection member can include a sacrificial member that is plastically deformable when a first force is imparted. In some aspects, the sacrificial member of the harness connection member can comprise an elongatable portion. In some aspects, the elongatable portion of the harness connection member can comprise one or more of a zig-zag portion, a sinusoidal portion, a helical portion, a cross member, a spring member, or a wire member. In some aspects, the sacrificial member of the harness connection member can comprise a compressible member.

In some aspects, the force damper comprises a drawbar-type spring including a compression member and a pair of oppositely disposed loop members, each of the loop members having a closed loop end portion and at least one leg end portion, each of the at least one leg end portions pass through the compression member, each of the at least one leg end portions have an end configured to engage with opposite ends of the compression member such that when sufficient forces are applied upon the closed loop end portions of each of the oppositely disposed loop members, the compression member is compressible. In some aspects, the compression member can comprise a compression spring. In some aspects, at least one leg end portion of at least one of the oppositely disposed loop members can include a weakened region that is capable of increased plastic deformation relative to the closed loop end portion thereof. In some aspects, the weakened region can comprise one or more of a zig-zag portion, a sinusoidal portion, or a helical portion. In some aspects, each of the oppositely disposed loop members can comprise a pair of leg end portions, and each leg of the pair of leg end portions of at least one of the loop members can include the sacrificially elongatable member and weakened region. In some aspects the weakened regions can include one or more of a zig-zag portion, a sinusoidal portion, or a helical portion.

In some aspects, the tear-away lanyard can have a length from 1-7 feet and can include one or more sacrificial tear-away regions. In some aspects comprising a plurality of sacrificial tear-away regions, each of the sacrificial tear-away regions can include a looped safety portion in conjunction with a sacrificial tear-way portion. In some aspects, a length of a leg of the looped safety portion can be from 0.75-1 feet. In some aspects, a length of a leg of each sacrificial tear-away region can be from 0.5-1 feet.

In some aspects, at least one of the force absorbing harness and the tear-away lanyard can further comprise an elastically deformable member.

In some aspects, at least one of the force absorbing harness and the tear-away lanyard further can comprise a looped safety portion in conjunction with an elastically deformable member that extends between ends of the looped safety portion.

In some aspects, the force absorbing harness can include a plurality of looped safety portions each in conjunction with a corresponding elastically deformable member, the plurality of looped safety portions disposed along webbed strapping of the force absorbing harness and at one or more of chest, back, and thigh portions thereof.

In some aspects, the compression spring can be formed from spring steel having a 3/16 to ¼ inch cross-sectional diameter, a spring rate of 100-350 lbs/inch, and a length in a non-compressed state that is from 1-6 inches. In some aspects, the compression spring can be formed to comprise a progressive-type spring and be from spring steel wire having a 3/16 to ¼ inch cross-sectional diameter, a spring rate of 100-350 lbs/inch, and a length in a non-compressed state that is from 1-6 inches.

These and other aspects, features, and advantages of the present disclosure will be readily appreciable from the following description in view the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIGS. 1A and 1B are front and rearward views, respectively, of a force absorbing harness;

FIGS. 2A and 2B are closeup before and after views, respectively, of a D-ring mount and D-ring assembly including a zig-zag configuration, subject to a sufficient force so as to cause deformation of the D-ring assembly;

FIGS. 3A and 3B are closeup before and after views, respectively, of a D-ring mount and D-ring assembly including a compression spring member configuration, subject to a sufficient force so as to cause sliding movement of portions of the D-ring assembly;

FIG. 3C is a cross-sectional view taken along line 3C-3C of FIG. 3B showing a type of spring member configuration;

FIGS. 3D-3G are closeup before and after views, respectively, of a D-ring mount and D-ring assembly including an expansion spring member configuration, subject to a sufficient force so as to cause elongation thereof;

FIGS. 4A and 4B are closeup before and after views, respectively, of a D-ring mount and D-ring assembly including a bent bar/weakened bar configuration, subject to a sufficient force so as to cause deformation of the D-ring assembly;

FIGS. 5A and 5B are closeup before and after views, respectively, of a D-ring mount and D-ring assembly including wire loop configuration, subject to a sufficient force so as to cause deformation of the D-ring assembly;

FIGS. 6A and 6B are closeup before and after views, respectively, of a force damper member subject to a sufficient force so as to cause deformation of the force damper;

FIGS. 7A and 7B are schematic before and after views, respectively, of a tear-away lanyard subject to a sufficient force so as to cause separation of sacrificial portions of the tear-away lanyard; and,

FIGS. 8A and 8B are schematic before and after view, respectively, of a force dampening system including a force absorbing harness, a tear-away lanyard, and a force damper, which system has been subject to sufficient force so as to cause one or more of deformation of the D-ring assembly, deformation of the force damper, cause separation of sacrificial portions of the tear-away lanyard, and elongation of the elastically deformable member/resilient portions of the force absorbing harness and tear-away lanyard.

### DETAILED DESCRIPTION

At the outset, it should be appreciated that like drawing numbers on different drawing views identify identical, or functionally similar, structural elements. It is to be understood that the claims are not limited to the specifically disclosed and illustrated aspects.

Furthermore, it is understood that this disclosure is not limited to the particular methodologies, materials and modifications described and as such may, of course, vary. It is also understood that the terminology used herein is for the purpose of describing particular aspects only and is not intended to limit the scope of the disclosure or claims.

Unless defined otherwise, all technical and scientific terms used herein have the same meaning as commonly understood to one of ordinary skill in the art to which this disclosure belongs. Although any methods, devices or materials similar or equivalent to those described herein can be used in the practice the example aspects.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

It should be appreciated that the term “substantially” and “generally” are synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, it is meant that: the elements are connected so that whenever one of the elements rotate, all the elements rotate; and relative rotation between the elements is not possible. Radial and/or axial movement of non-rotatably connected elements with respect to each other is possible, but not required. Additionally, “plastic deformation” is intended to mean instances when a sufficient load is applied to a material that causes a permanent change in shape to that material.

Adverting now to the figures, it should be appreciated that the figures depict various aspects. An elevated work surface, e.g., roof, a falling object, e.g., a worker, a tool, a container filled with materials, etc., are not shown in the figures. One of ordinary skill in the art will readily appreciate the type, form and arrangement of each of the foregoing structures and therefore depiction in the figures is unnecessary. For the purpose of clarity in the detailed description, these structures are not included in the figures; however, the structures are discussed herebelow.

Force Damping System

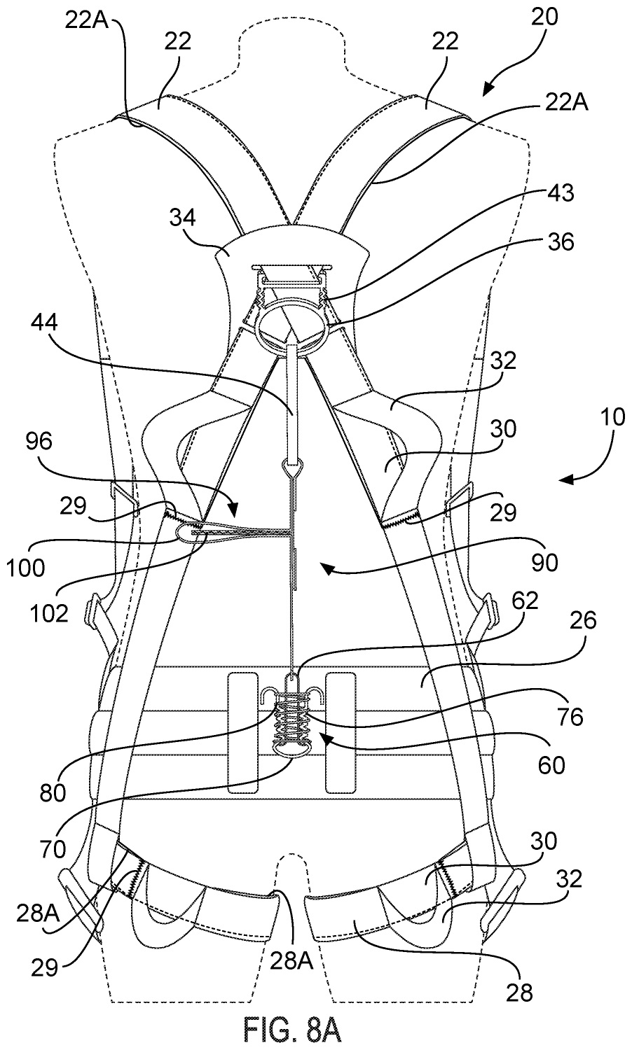

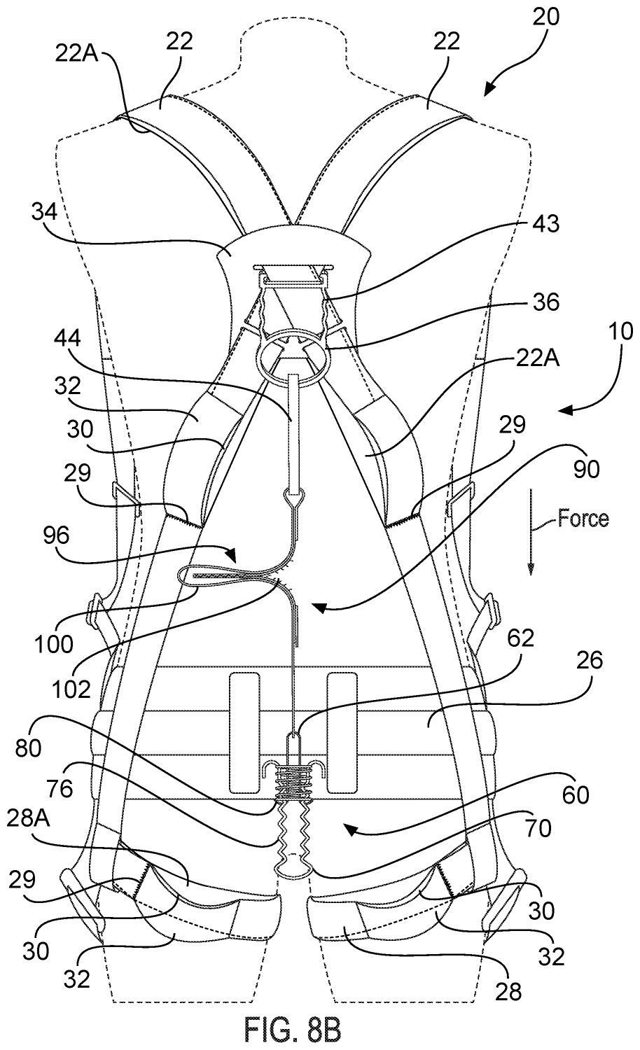

Referring now to FIGS. 8A-8B, force damping system 10 according to one or more aspects described and illustrated herein is shown as generally including force absorbing harness 20, tear-away lanyard 90, and force damper 60. As may be appreciated from the figures, force absorbing harness 20 is connectable to a first end loop of tear-away lanyard 90 via, for example, a connector 44, e.g., a carabiner, a second end loop of the tear-away lanyard is connectable to a first U-shaped loop 62 of force damper 60 by means of, for example, a connector, e.g., a not shown carabiner, and second U-shaped loop 70 of force damper 60 is connectable, e.g., via a connector such as a carabiner, to a fixed object (not shown). It should be appreciated that while FIGS. 8A and 8B illustrate the components of the force damping system as being ordered in a harness-lanyard-force damper configuration, other orders of the components are contemplated and encompassed by the instant disclosure. Additionally, it should be further appreciated that while FIGS. 8A and 8B illustrate a force damping system as including each of force absorbing harness 20, a tear-away lanyard 90, and a force damper 60 as will be described later, force damping system 10 can be configured to include fewer than all of the above-described system components or additional components. For example, in various non-limiting aspects, the system can include a non-force absorbing harness along with one or more other components, a force absorbing harness along with a tear-away lanyard but no force damper, or one or more of each component, e.g., a force absorbing harness along with a pair of lanyards or a pair of force dampers that may be, for example, parallelly connected, etc.

Force Absorbing Harness

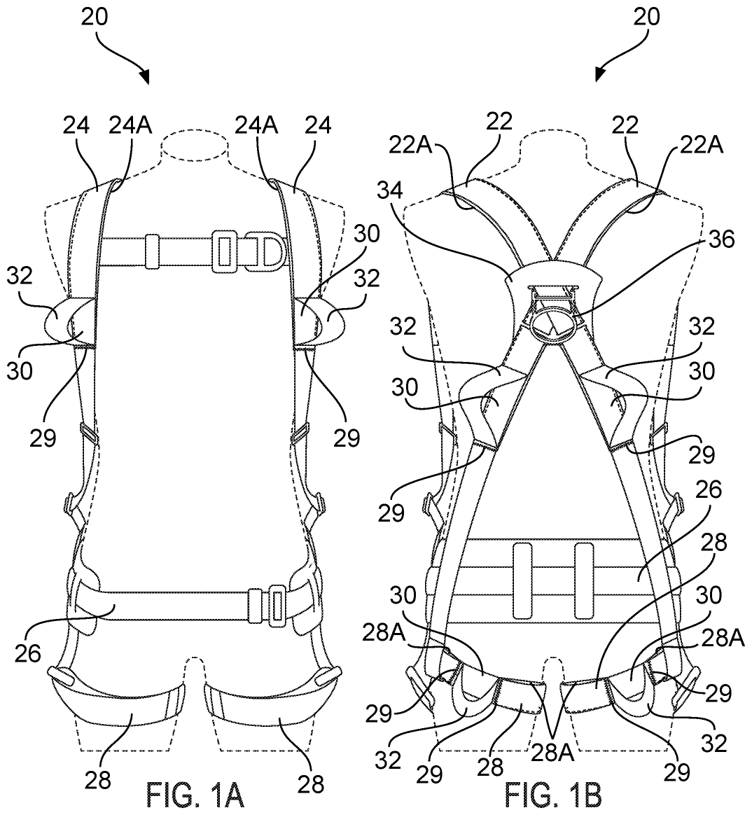

Referring now to FIGS. 1A-5B, force absorbing harness 20 is provided so as to be worn by a user and is shown as including outer backstrap portions 22, inner backstrap portions 22A, outer shoulder/chest strap portions 24, inner shoulder/chest strap portions 24A, belt portion 26, and outer thigh strap portions 28, inner thigh strap portions, D-ring mount assembly 34, and D-ring assembly 36. Much like most known body harnesses, the various straps, belts, and connectors that form force absorbing harness 20 can be fabricated from materials such as nylon webbing, leather, various metals, plastics, and the like of sufficient strength for securing a wearer, and in accordance with ANSI or OSHA requirements, and/or in accordance with requirements that may be set, for example, by other non-governmental organization or trade associations. In aspects, the harness can be fabricated from nylon webbing that is 1-2 inches in width. As may be appreciated from the figures, force absorbing harness 20 is configured to comprise one or more force absorbing features. For example, force absorbing harness 20 can be configured to comprise an outer harness portion and an inner harness portion connected to one another, as by for example, sacrificial stitching, that is configured to allow the outer harness portion to partially separate away from the inner harness portion when a sufficient force is applied upon the harness. In aspects, force absorbing harness 20 can include harness outer backstrap portions 22, outer shoulder/chest strap portions 24, and outer thigh strap portions 28 connected to respective inner backstrap portions 22A, inner shoulder/chest strap portions 24A, and inner thigh strap portions 28A as by, for example, sacrificial stitching (not shown). As may be appreciated from the figures, safety/retaining stitching 29 in accordance with ANSI or

OSHA requirements can be provided to prevent complete separation of the outer harness from the inner harness to thereby allow the inner harness to remain snugly fit upon the user. As may be appreciated from a comparison of FIGS. 8A and 8B, when a wearer suffers a fall, for example, and a sufficient force is applied upon the harness, the not shown sacrificial stitching securing the outer harness portion to the inner harness portion can be sacrificially torn, thereby allowing the outer harness portion to separate and extend away from the inner harness portion and absorb some of the force resulting from a fall, yet simultaneously allowing the inner harness portion to maintain a snug fit close to the wearer's body and secure the wearer.

In addition to the above, in some aspects force absorbing harness 20 can also be configured to comprise one or more elastically deformable member/resilient portions 30, e.g., elastic or rubber material, in conjunction with looped safety portions 32. Elastically deformable member/resilient portions 30 and looped safety portions 32 are generally disposed along those areas/regions of force absorbing body harness 20 that tend to produce injury to a wearer of the harness, for example, in the event of a fall. As may be appreciated from a comparison of FIGS. 8A and 8B, when a wearer suffers a fall, for example, the elastically deformable member/resilient portions 30 and looped safety portions 32 are configured to extend and elongate so as to reduce the forces that are applied upon the wearer's body at such locations. As compared to conventional-type harnesses not including such elongatable or elastically deformable components, force absorbing harness 20 including elastically deformable member/resilient portions 30 and looped safety portions 32 can reduce the incidence of injury to the wearer. In aspects, elastically deformable member/resilient portions 30 can have a force absorbing ability in a range of 40-80 lbs/inch of stretch, an overall length of from 3-5 inches, and a length between looped safety portions 32 (in a non-extended state) can be in the range of from 1-3 inches. Additionally, it should be appreciated that while elastically deformable member/resilient portions 30 and looped safety portions 32 are illustrated as comprising solid plastics or rubber in association with webbed strap-type members, such components can be in the manner of one or more elastic members covered in an accordion-like sheath of nylon webbed material, i.e., an accordion-like sheath having an extended length greater than that of the one or more inner elastic members in a non-elongated state. Additionally, while FIGS. 1A and 1B illustrate a single elastically deformable member/resilient portion 30 and looped safety portion 32 as corresponding to each of respective back, shoulder/chest, and thigh straps, the number of elastically deformable member/resilient portions 30 and looped safety portions 32 corresponding to each strap could be configured to be more or less, or otherwise disposed. In addition to the above, while it is not shown in the figures, looped safety portions 32 can be utilized in association with one or more tear-away members, e.g., tear-tape having a 200-1200 lbs. ANSI rating, and in some aspects tear-tape having a 900-1200 lbs. ANSI rating currently commercially available from Oppermann Webbing, Inc. of Piedmont, S.C. Also, while the aforementioned describes and illustrates one or more various components in association with inner and/or outer harness portions, the one or more various components, e.g., the elastically deformable member/resilient portions 30 and looped safety portions 32, accordion-like sheath, and/or tear-away members, etc., can be associated with a harness that does not include both inner and outer harness portions.

As shown in FIG. 1B, force absorbing harness 20 can include D-ring assembly mount 34 that can include one or more slots so as to receive and secure backstrap portions 22 therethrough in a cross-wise manner such that the D-ring assembly mount 34 may be slidably disposed proximate an upper central portion of a wearer's back. In addition to securing backstrap portions 22, D-ring assembly mount 34 is also configured to work in conjunction with backstrap portions 22 so as to secure D-ring assembly 36. D-ring assembly mount 34 can be fabricated from various strong, lightweight materials such as plastics capable of withstanding the forces resulting from a falling object, lightweight metals such as aluminum, and/or metals such as steel, as well as various alloys.

D-Ring Assembly

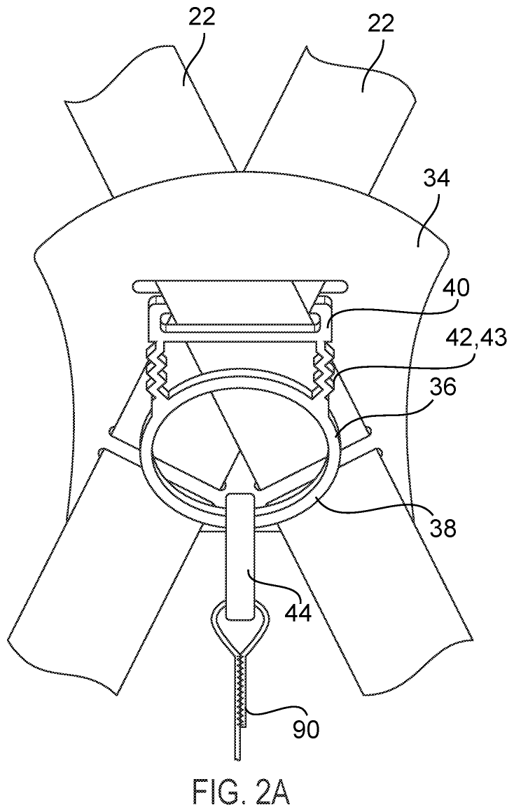

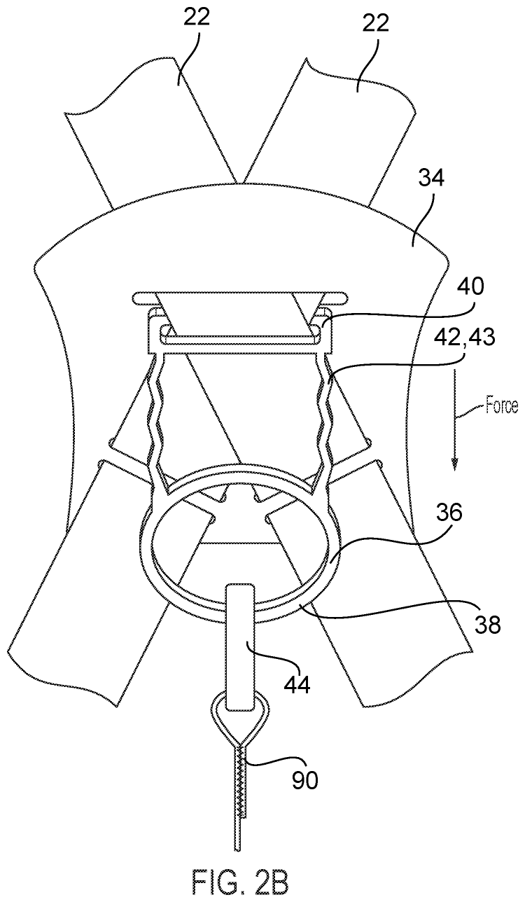

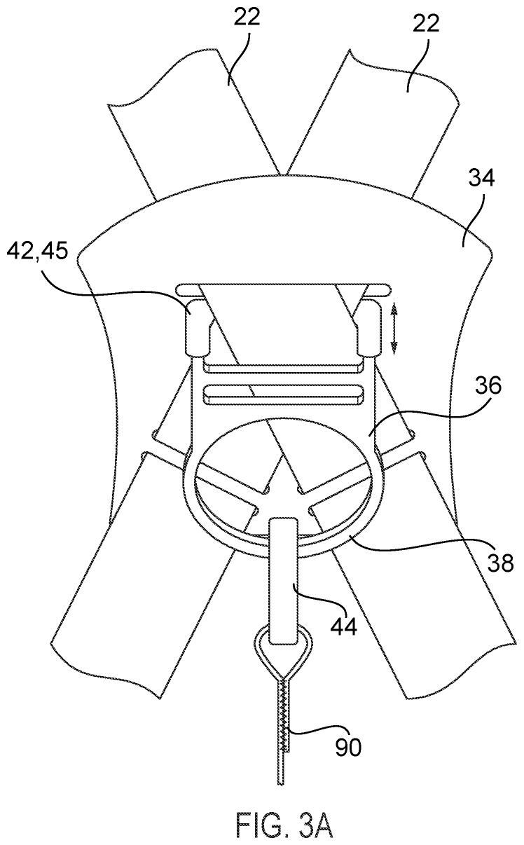

As shown more clearly in FIGS. 2A-5B, D-ring assembly 36 can generally include D-ring loop 38, D-ring strap connector 40, and sacrificially elongatable/weakened member 42. D-ring loop is generally provided for securing a tether thereto such as tear-away lanyard 90 via a connector 44, e.g., a carabiner. D-ring strap connector 40 generally comprises a slot or aperture for slidably receiving one or more backstraps 22 therethrough such that the D-ring assembly 36 is secured to the force absorbing harness 20 between straps 22 and D-ring assembly mount 34. D-ring assembly 36 can be formed from lightweight metals such as aluminum, and/or metals such as steel, as well as various alloys or combinations thereof. However, as compared to conventional D-rings, D-ring assembly 36 includes sacrificially elongatable/weakened member 42, which can be a component or region of the D-ring assembly that is weakened, extendable, or elongatable relative to other D-ring assembly components when exposed to a sufficient force, e.g., those forces associated with a falling person or object.

As shown in FIGS. 2A-2B, D-ring assembly 36 can include sacrificially elongatable/weakened member 42 in the form of a plurality of accordion-like zig-zag structures 43 that are configured to undergo plastic deformation when exposed to a sufficient force in the direction shown by the arrow, e.g., those forces associated with a falling person or object. It should be appreciated that while FIGS. 2A and 2B depict sacrificially elongatable/weakened member 42 in the form of a plurality of accordion-like zig-zag structures 43, sacrificially elongatable/weakened member 42 can be configured other than an accordion-like triangular zig-zag structures and can include round or square sinusoidal structures, or helical structures, or combinations thereof, for example. In some aspects, D-ring assembly 36 can be fabricated from suitable metals and alloys thereof. In some aspects, D-ring assembly 36 can be fabricated from chrome silicon steel, cold rolled steel, hot rolled steel, stainless steel, spring steel, round or flat stock, cast material having a spring rate of 100-350 lbs./inch, annealed steel, 1048/1050 annealed steel, 1018 cold rolled steel, and/or tempered steel. In some aspects, D-ring assembly is from 3/16-¼ inch in thickness. In some aspects D-ring assembly can be fabricated from steel plate that is ⅛-¼ inch in thickness and ½ inch in width. In some aspects, one or more portions of D-ring assembly 36 may be processed according to one or more known metallurgical processes so as to strengthen or weaken portions thereof, e.g., zig-zag structures could be processed so to be more likely to undergo plastic deformation as compared to other portions of the D-ring assembly and/or processed to be progressively plastically deformable.

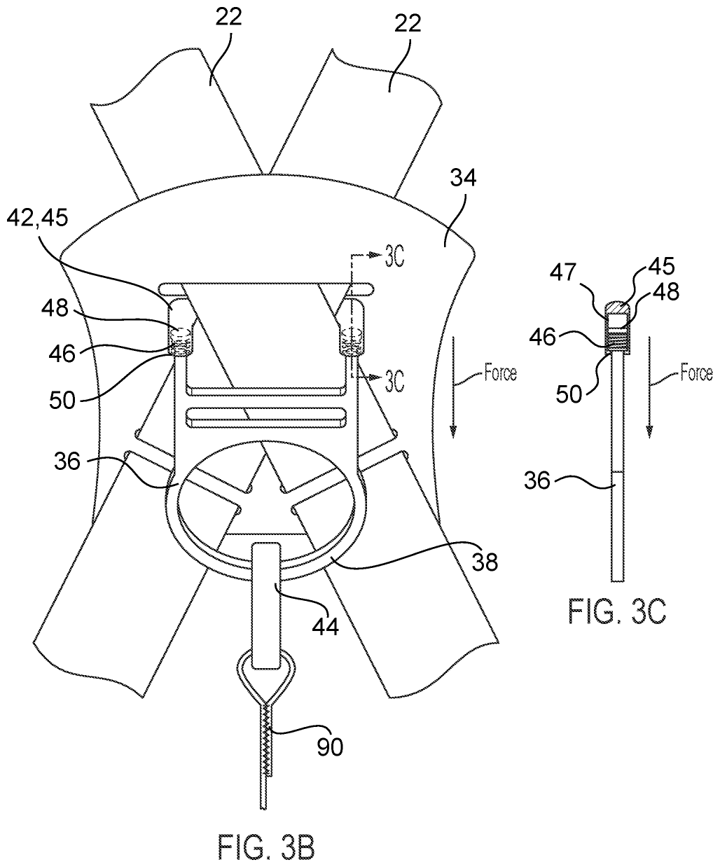

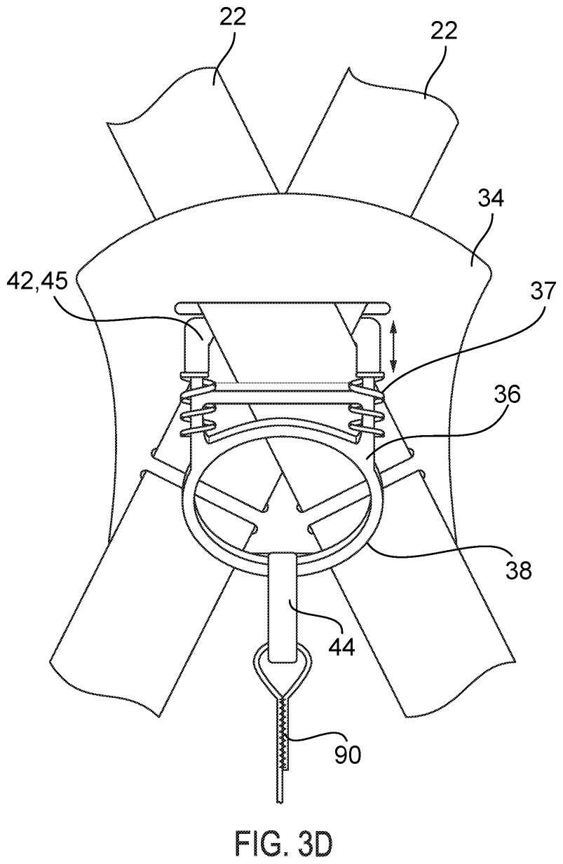

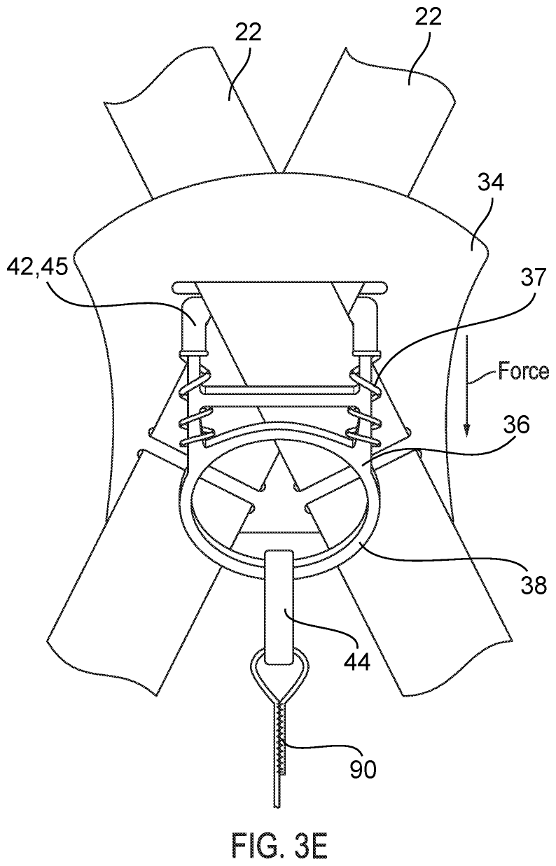

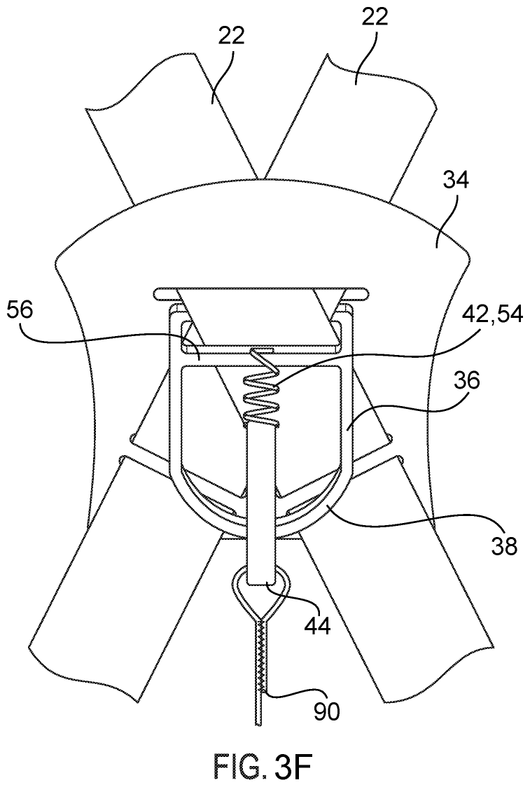

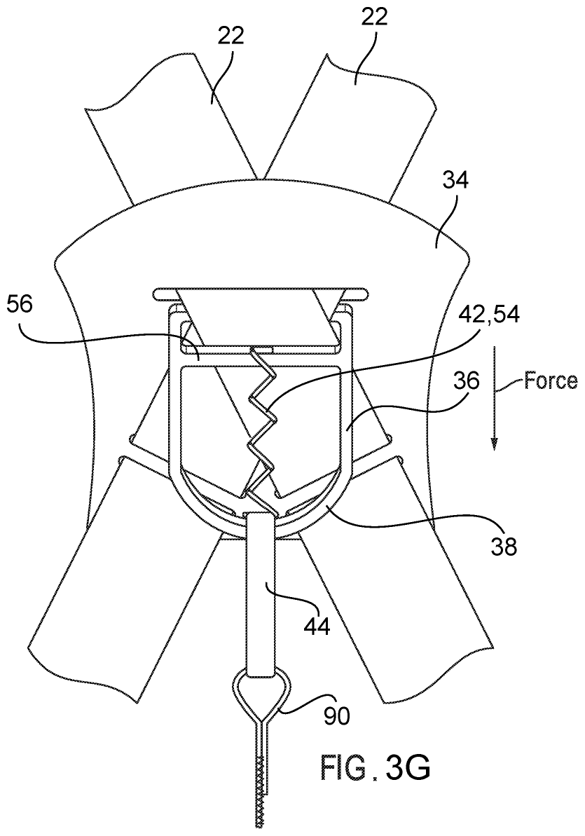

As shown in FIGS. 3A-3C, D-ring assembly 36 can include elongatable/weakened/extendable member 42 in the form of a compression spring member configuration 45. In such configuration, as shown in FIG. 3C, D-ring assembly 36 can be configured to include one or more channels 37 that allow one or more D-ring endposts 48 to be slidably received therein. Within the one or more channels 37, one or more compression members 46, e.g., a compression spring, can be disposed between the one or more endposts 48 and one or more stops/abutments 50 of the one or more channels 37. Hence, as shown in a comparison of FIGS. 3A and 3B, upon application of a sufficient force in the direction of the arrow, that portion of the D-ring assembly corresponding to the D-ring loop can be caused to move in the direction of the arrow thereby causing compression member 46 to be compressed and attenuate the forces applied upon the D-ring assembly and the wearer of the harness. It should be appreciated that while compression member 46 is illustrated as being in the form of a compression spring, one or more other compressible structures can be utilized, e.g., rubber, plastics, or materials having a compressible/collapsible/frangible cellular matrix can be utilized. While D-ring assembly 45 of FIGS. 3A-3C has been described and illustrated as including a compression member 46, it should be understood that a similar configuration utilizing one or more expansion/elongating members, e.g., one or more expansion springs, is contemplated. In aspects including one or more compression springs, the one or more compression springs can be fabricated from suitable metals and alloys thereof. In some aspects, the one or more compression springs can be fabricated from chrome silicon steel, cold rolled steel, hot rolled steel, stainless steel, spring steel. In some aspects, the one or more compression springs are formed from round wire having a wire diameter from 3/16-¼ inches, have an uncompressed length of from 1-7 inches, and more preferably, 1-3 inches, an overall diameter of 2 inches, and a spring rate from 100-350 lbs/inch, and preferably, from 150-200 lbs/inch. In some aspects, one or more portions of the one or more compression springs can be processed according to one or more known metallurgical processes so as to strengthen or weaken portions thereof, e.g., annealing. In some aspects, the one or more compression springs can be selected to be purposefully overstressed, i.e., subject to forces beyond their spring rating and/or selected so as to experience plastic deformation, without experiencing complete failure (breakage). In some aspects the one or more compression springs can comprise progressive-type springs having unequal distances between each coil over the length of the spring. Additionally, in the case of a D-ring assembly utilizing channels and compression or later discussed expansion springs disposed within the channels, fall or force indicators may also be provided in order to show that the D-ring assembly has been previously subject to a force such that it should not be reused.

As shown in FIGS. 3D-3E, D-ring assembly 36, which is similar D-ring assembly 45 of FIGS. 3A-3C, and similarly includes one or more channels 37 and stops/abutments 50 (not shown) that allow one or more D-ring endposts 48 (not shown) to be slidably received therein, can be configured to comprise an expansion member, such as one or more expansion springs 37, which can be disposed within channel 37 (not shown), or disposed on the outside of channel 37 (shown). In aspects including one or more expansion springs, the one or more expansion springs can be fabricated from suitable metals and alloys thereof. In some aspects, the one or more compression springs can be fabricated from chrome silicon steel, cold rolled steel, hot rolled steel, stainless steel, spring steel. In some aspects, the one or more compression springs are formed from round wire having a wire diameter from 3/16-¼ inch, have an unextended length of from 1-3 inches, and more preferably, 2.5 inches, an overall diameter of 0.75 inches, and a spring rate from 100-350 lbs/inch, and preferably, about 178 lbs/inch. In some aspects, one or more portions of the one or more expansion springs can be processed according to one or more known metallurgical processes so as to strengthen or weaken portions thereof, e.g., annealing. In some aspects, the one or more expansion springs can be selected to be purposefully overstressed, i.e., subject to forces beyond their spring rating and/or selected so as to experience plastic deformation, without experiencing complete failure (breakage). In some aspects the one or more expansion springs can comprise progressive-types springs having unequal distances between each coil over the length of the spring. As poreviosuly mentioned, in the case of a D-ring assembly utilizing channels and compression or expansion springs disposed within the channels, fall or force indicators may be provided in order to show that the D-ring assembly has been previously subject to a sufficient force such that it should not be reused.

As shown in FIGS. 3F-3G, in aspects D-ring assembly 36 can be configured to comprise one or more expansion springs 54 secured to crossmember 56. In aspects including one or more expansion springs 54, the one or more expansion springs 54 can be formed from round wire having a wire diameter from 3/16-¼ inch, have an unextended length of from 1-3 inches, and more preferably, 1-1.5 inches, an overall diameter of 0.75 inches, and a spring rate from 100-350 lbs/inch, and preferably, about 178 lbs/inch. In some aspects, one or more portions of the one or more expansion springs can be processed according to one or more known metallurgical processes so as to strengthen or weaken portions thereof, e.g., annealing. In some aspects, the one or more expansion springs can be selected to be purposefully overstressed, i.e., subject to forces beyond their spring rating and/or selected so as to experience plastic deformation, without experiencing complete failure (breakage). In accordance therewith, as expansion spring 54 is selected to be overstressed and undergo plastic deformation, the distance between crossmember 56 and D-Ring loop 38 ranges from 3-6 inches so as to accommodate the expansion of the spring therein.

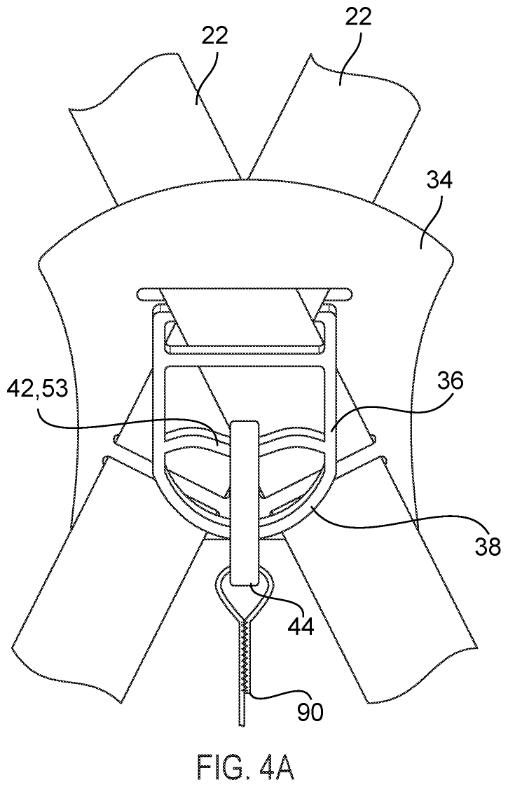

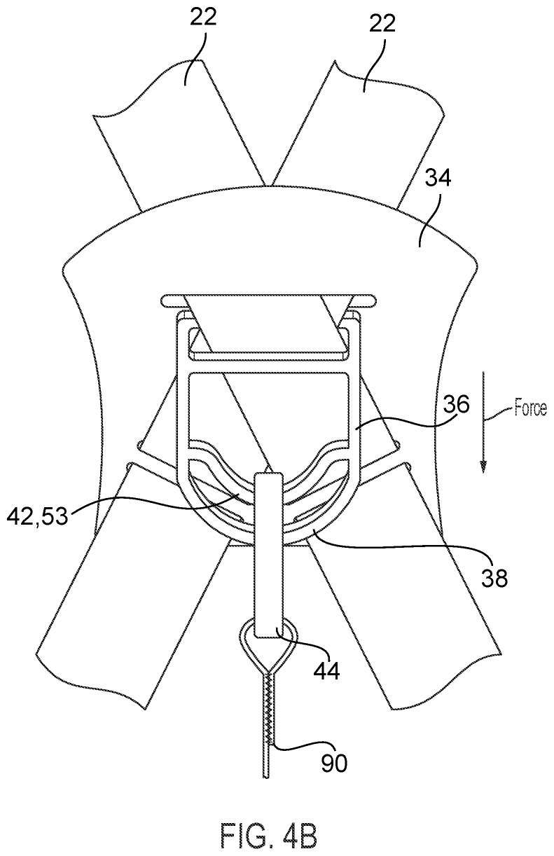

As shown in FIGS. 4A-4B, D-ring assembly 36 can include sacrificially elongatable member 42 in the form of bent bar/weakened bar member 53 wherein a portion of the D-ring assembly configured to receive, for example, connector 44, can be pre-shaped or structurally weakened relative to the remaining portions of the D-ring assembly 36. In such cases, as shown in FIG. 4B, upon application of a sufficient force in the direction of the arrow, sacrificially elongatable/weakened member 42, 53 may be elongated and bent in the direction of the arrow such that the forces applied upon a user may be absorbed or attenuated. As may be appreciated from the figures, the bent bar/weakened bar member 53 is disposed within the inner diameter of the D-ring loop 38 and the connector 44 is connectable to the D-ring assembly 36 such that it is capable of engaging both the D-ring loop 38 and the bent bar/weakened bar member 53—this provides an important safety mechanism in the event that the forces applied to the bent bar/weakened bar member 53 exceed the carrying capacity thereof. In some aspects, D-ring assembly 36 including bent bar/weakened bar member 53 can be fabricated from suitable metals and alloys thereof. In some aspects, D-ring assembly 36 including bent bar/weakened bar member 53 can be fabricated from chrome silicon steel, cold rolled steel, hot rolled steel, stainless steel, spring steel, round or flat stock, cast material annealed steel, 1048/1050 annealed steel, 1018 cold rolled steel, and/or tempered steel having a spring rate of 150-350 lbs/inch, and in some cases, a spring rate of 150-200 lbs./inch. In some aspects, D-ring assembly is from 3/16-¼ inch in thickness. In some aspects D-ring assembly including bent bar/weakened bar member 53 can be fabricated from steel plate that is ⅛-¼ inch in thickness and ½ inch in width. In some aspects, one or more portions of D-ring assembly 36 including bent bar/weakened bar member 53 may be processed according to one or more known metallurgical processes so as to strengthen or weaken portions thereof, e.g., annealing, drawing, etc., and/or bent bar 53 can be processed so to be more likely to undergo plastic deformation as compared to other portions of the D-ring assembly.

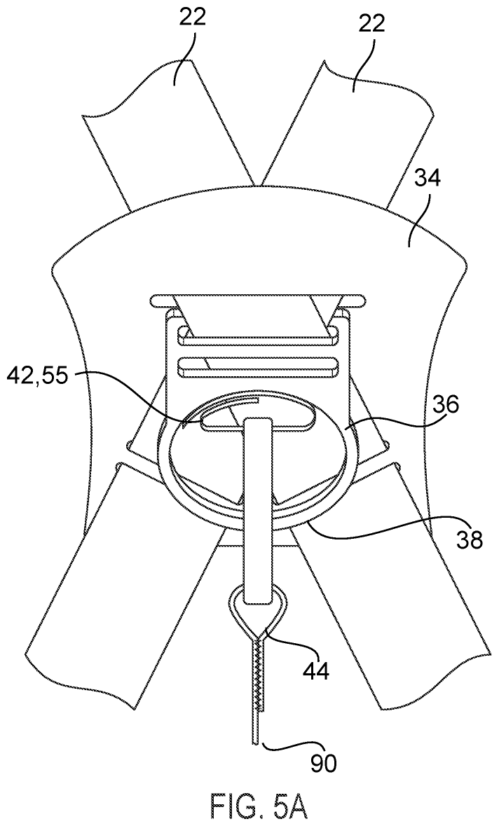

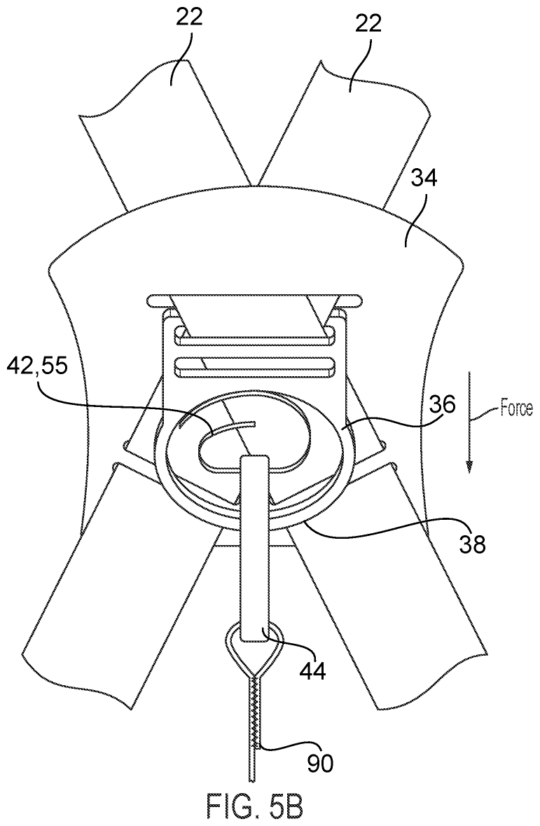

As shown in FIGS. 5A-5B, D-ring assembly 36 can include sacrificially elongatable member 42 in the form of wire loop member 55 capable of connecting, for example, connector 44. In accordance with such configuration, a plastically deformable spring wire in the form of a loop can be secured to the D-ring loop 38 such that when a sufficient force is applied thereto in the direction of the arrow, the sacrificially elongatable wire loop member 55 undergoes plastic deformation to absorb and attenuate the forces applied upon a user. As may be appreciated from the figures, the wire loop member 55 is disposed within the inner diameter of the D-ring loop 38 and the connector 44 is connectable to the D-ring assembly 36 such that it is capable of engaging both the D-ring loop 38 and the wire loop member 55—this provides an important safety mechanism in the event that the forces applied to the wire loop member 55 exceed the capacity thereof. In aspect, wire loop member 55 can be formed from round spring wire that is from ⅛ to ¼ inches thick and have a spring rating of 100-350 lbs/inch. In some aspects, wire loop member 55 can be formed from flat spring steel that is 3/16-¼ inches thick, and which has a width of from ¼ to ½ inches. In some aspects, wire loop member 55 can processed according to one or more known metallurgical processes so as to strengthen or weaken portions thereof, e.g., annealing.

Tear-Away Lanyard

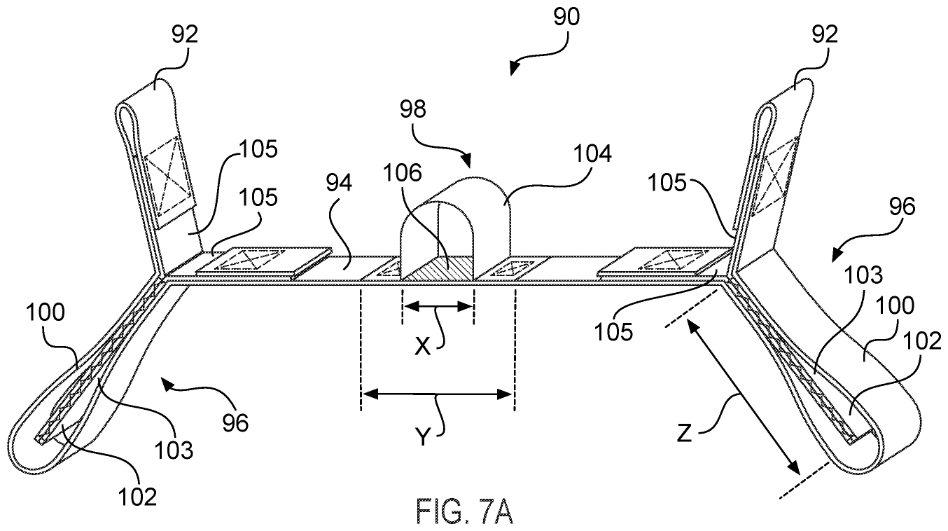

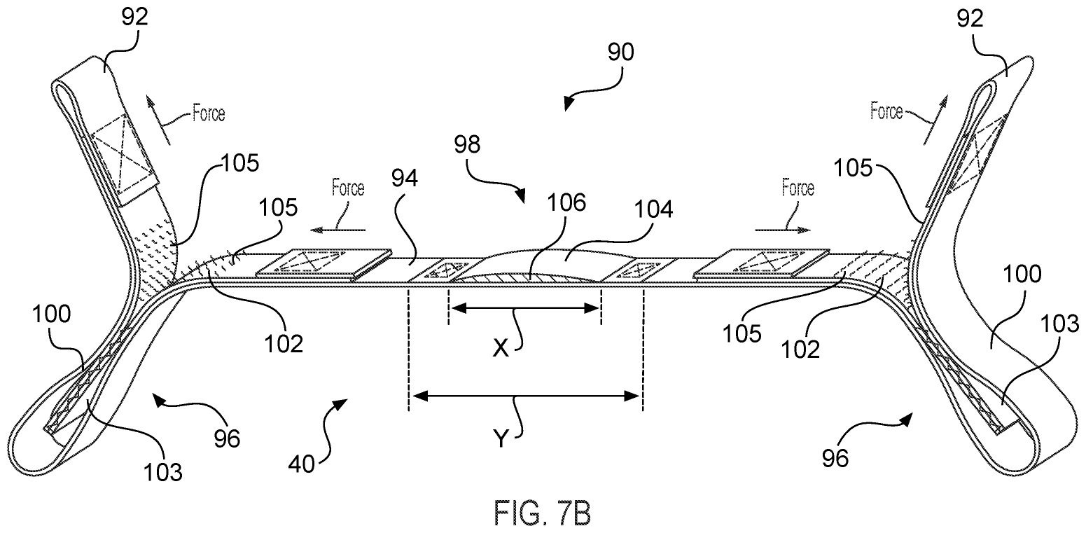

Referring now to FIGS. 7A and 7B, which illustrate tear-away lanyard 90. As may be appreciated from the figures, tear-away lanyard 90 is generally provided to connect a harness, e.g., force absorbing harness 20 worn by a user, to an anchor point such as a wall or a tie-off safety cart used in the roofing field for purposes of preventing injury as may occur as a result of a fall from a height. In accordance therewith, tear-away lanyard 90 can be formed from an appropriate strapping material such as nylon webbing typically used in the fall prevention field and can comprise a pair of terminal ends each including strap connecting portion 92, which as shown in FIGS. 7A and 7B each form a loop capable of receiving, for example connector 44 such as a carbiner, for connecting to a harness and an anchor point. Disposed between each strap connecting portion 92 is intermediate strap portion 94, as well as a plurality of tear-away portions 96. Each tear-away portion 96 is formed of a looped safety portion 100 and a sacrificial tear-away portion 102.

FIGS. 7A and 7B also show that tear-away lanyard 90 can further comprise one or more resilient portions 98, which can be disposed between each of the strap connecting portions 92 and each of the tear-away portions 96. Resilient portion 98 comprises looped safety portion 104 and elastically deformable member/resilient portion 106, e.g., an elastic or a rubber material capable of deformation. In some aspects, elastically deformable member/resilient portion 106 has an overall length Y from 3-5 inches, a length X from 1-3 inches, and comprises an elastic material having a rating of 40-80 lbs per inch of stretch. In some aspects, elastically deformable member/resilient portion 106 has an overall length Y of about 5 inches, a length X of about 3 inches, and comprises an elastic material having a rating of about 40 lbs per inch of stretch. Elastically deformable member/resilient portion 106 and looped safety portion 104 are generally disposed at a position between the each of the strap connecting portions 92 and are configured to extend and elongate so as to reduce the forces that may be applied upon a user in the event of a fall.

In some aspects, the width of the various components of the tear-away lanyard, e.g., strap connecting portions 92, intermediate strap portion 94, tear-away portions 96, resilient portion 98, can be between 1-2 inches. Additionally, in some aspects, tear-away lanyard 90 can have an overall length of between 2-5 ft. in an unused state as measured from the terminal ends of each strap connecting portion 92. In some aspects, in a used and torn state, e.g., as may result in the event of a fall, the tear-away lanyard can have a length between 1-7 ft, and preferably, from 1-6 ft.

With regard to strap connecting portions 92, intermediate strap portion 94, and looped safety portions 100, 104, such components can comprise a fabric webbing, such as nylon webbing known in the field of fall prevention. With regard to sacrificial tear-away portions 102, as may be appreciated from the figures, sacrificial tear-away portions 102 can be formed by joining intermediate portions 103 of each a pair of strap members together by, for example, stitching, adhesives, hook and loop members, or combinations thereof, and then joining the remaining free ends 105 thereof to a respective intermediate strap portion 94 and a respective strap connecting portion 92. In some aspects, joined intermediate portions 103 have a length Z between 0.5-1 feet, and in some aspects is approximately 10 inches in an unused and untorn state. In some aspects, a length of looped safety portions 100 is between 0.75-1 feet. In some aspects, sacrificial tear away portions 102 comprise tear-tape having a 200-1440 lbs ANSI rating, and preferably a tear-tape having a 200-900 lbs. ANSI rating. For example, in some aspects, tear-tape having a 900-1200 lbs. ANSI rating currently commercially available from Oppermann Webbing, Inc. of Piedmont, S.C. can be utilized. In some aspects, sacrificial tear away portions 102 can include one or more holes or punch-holes (not shown) disposed on center and along a portion of the length of one or more of the tear away portions 102. In some aspects, remaining free ends 105 secured to the looped safety portions 100 and intermediate portions 94 have a length of between 1-3 inches, and preferably from 2-3 inches and are secured according to ANSI and/or OSHA requirements.

It should be appreciated that while FIGS. 7A and 7B illustrate a single elastically deformable member/resilient portion 106 and looped safety portion 104, the number of elastically deformable member/resilient portions 106 and looped safety portions 104 could be more or otherwise disposed. Additionally, while tear-away lanyard 90 is shown as comprising a planar fabric webbing and other generally planar components, it should be appreciated that tear away lanyard 90 could be formed to include a protective outer sheath and internal tear-away portions 96 and/or one or more internal elastically deformable member/resilient portions 106. In such cases, the tear-away portions 96 and/or the elastically deformable member/resilient portion 106 could be covered by an accordion-like outer sheath of webbed material, i.e., the accordion-like sheath having an extended length greater than that of the internal components of the tear-away lanyard. In some sheathed aspects, the internal components could comprise an elongatable braid or elastic braid. In some aspects, one or more lengths of intermediate portions 94 can be secured upon itself so, as by for example, the use of stitching, adhesives, hook and loop, etc. so as to comprise one or more not shown accordion-like pleated structures capable of being sacrificially elongated upon application of a sufficient force. In some aspects, the not shown accordion-like pleated structures could form pleats having a pleat length of from 1-2 inches and be capable of extending between 3-6 inches.

Force Damper Member

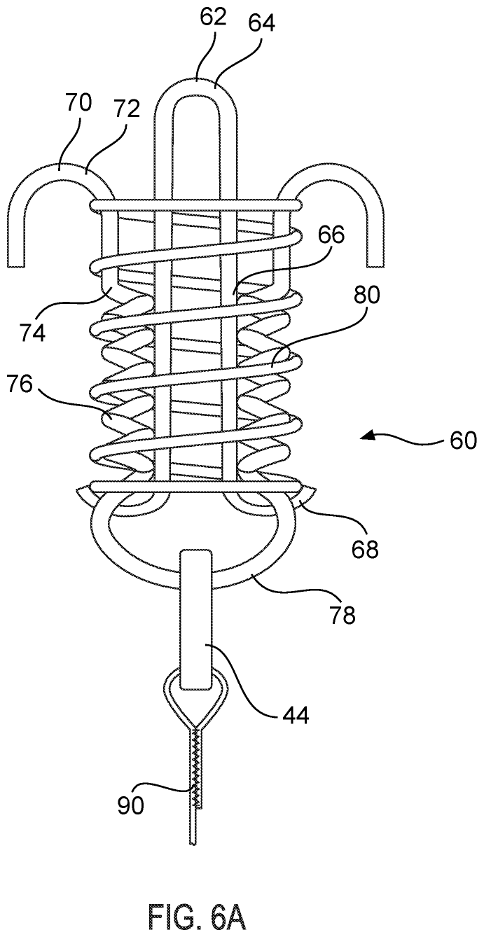

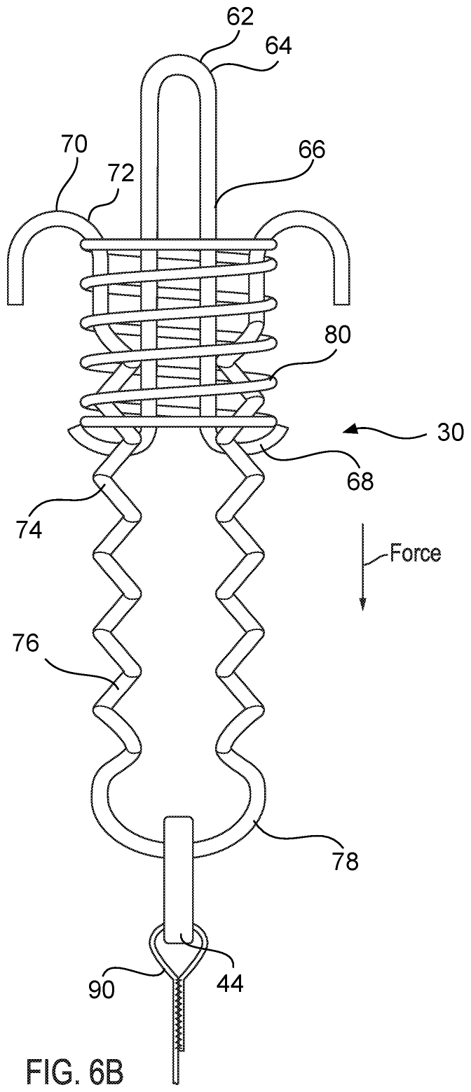

Referring now to FIGS. 6A and 6B, force damper member 60 can generally be in the form of a drawbar-type spring and includes first U-shaped loop 62, second U-shaped loop 70, and compression member 80. First U-shaped loop 62 comprises closed loop end portion 64, leg portion 66, and open end U-portion 66. Second U-shaped loop 70 comprises closed loop end portion 78, leg portion 74, and open end U-portion 72. As shown in FIGS. 6A and 6B, second U-shaped loop 70 is shown as further including sacrificial/elongatable/weakened region 76 disposed between closed loop end portion 78 and open end U-portion 72. While not apparent from the figures, which have been provided for illustrative purposes only and their shown proportions not necessarily be relied upon, each of first U-shaped loop 62 and second U-shaped loop 70 can be formed from suitable metals and alloys thereof. In some aspects, the first U-shaped loop 62 and second U-shaped can be fabricated from chrome silicon steel, cold rolled steel, hot rolled steel, stainless steel, spring steel, flat stock having a thickness between 3/16-¼ inches and a width between 3/16-½ inches, or round wire having a wire diameter from 3/16-¼ inches, and have a length of from 3-10 inches. In some aspects, the first U-shaped loop 62 and second U-shaped loop 70 is preferably formed from chrome silicon steel, 1048/1050 annealed steel, or 1018 cold rolled/hot rolled steel. Additionally, while not shown, force damper member first U-shaped loop 62 and second U-shaped can include a lightweight flexible sheath or covering formed from, for example, a durable fabric such as oiled canvas, Kevlar, etc., which can serve to protect the force damper member from environmental factors and/or serve as an indicator that the force damper has been previously subjected to a force rendering it inoperable for further use. For example, such covering could be configured to be torn in a predetermined manner or one or more force damper components could extend from the sheath or covering to indicate prior use.

Compression member 80 can be in the form of a compression spring having a length and inner and outer diameters. In the case where compression member 80 is formed from a compression spring, the compression spring may be formed from a suitably strong material such as cold rolled steel, hot rolled steel, stainless steel, spring steel, chrome silicon steel, etc. having a wire diameter of between 3/16-¼ inches, a length of between 5-7 inches, an overall outer diameter of 1.5-2 inches, and an overall spring rate of approximately 100-350 lbs./inch. As may be appreciated, compression member 80 can comprise structures other than a compression spring and may be formed from materials such as resilient plastics, rubbers, and the like.

In some aspects, compression member 80 can comprise a progressive-type compression spring formed from spring wire having a diameter of between 3/16 and ¼ inches. In some aspects, compression member comprising a progressive-type compression spring can have an overall inner diameter of about 1 ¾ inches, an overall outer diameter of about 2 inches, an overall uncompressed length of approximately 6 inches, and a spring rate between 500-1400 lbs/inch at full deflection. In some aspects, a progressive-type compression spring transitions from a first end portion that is approximately 2 inches in length that has a spring rate of about 630 lbs/inch at full deflection, to an intermediate portion that is approximately 2 inches in length that has a spring rate of about 600 lbs/inch at full deflection, and to a second end portion that is approximately 2 inches in length that has a spring rate of about 750 lbs/inch at full deflection. In some aspects including a progressive-type compression spring, the pitch angle of coils of the first end portion is approximately 10-11 degrees, and preferable about 10.8 degrees, the pitch angle of coils of the intermediate portion is between 11-12 degrees, and preferably 11.8 degrees, and the pitch angle of coils of the second end portion is between 12-13 degrees, and preferably 12.8 degrees.

Each of first U-shaped loop 62 and second U-shaped loop 70 have leg portions 66 and 74 that have a length longer than compression member 80 and a width smaller than the inner diameter of compression member 80 such that the leg portions may be received therein and passed through compression member 80 such that closed loop end portions may extend beyond the terminal ends of compression member 80 and serve as points of connection for connecting a tether, for example, and/or for anchoring the force damper member. Additionally, despite the fact that FIGS. 6A and 6B show that closed loop end portion 78 has a width greater than the inner diameter of compression member 80, it should be appreciated that each of first U-shaped loop 62 and second U-shaped loop 70 can have closed loop end portions 64 and 78 that have a width that is smaller than the inner diameter of compression member 80. Each of first U-shaped loop 62 and second U-shaped loop 70 also have open end U-portions 68 and 72 that have a width greater than the outer diameter of the compression member 80 such that the open end U-portions 68 and 72 engage opposite terminal ends of compression member 80. As previously mentioned, closed loop end portions 64 and 78 are provided for serving as connection points for securing a tether or lanyard on a respective one end, and being secured to an anchor point, for example, on the opposite end. Hence, when sufficient force oppositely directed forces are applied to respective closed loop end portions 64 and 78, the first U-shaped loop 62 and second U-shaped loop 70 are disposed in opposite directions to thereby cause the compression of compression member 80 and elongation and plastic deformation of sacrificial/elongatable/weakened region 76, thereby absorbing and attenuating the forces applied thereto.

As previously indicated, sacrificial/elongatable/weakened region 76 is shown in FIGS. 6A and 6B as being disposed between closed loop end portion 78 and open end U-portion 72 of second U-shaped loop 70 and is provided for purposes of, in addition to compression member 80, further absorbing and attenuating forces that may be applied to force damper member 60. In accordance therewith, sacrificial/elongatable/weakened region 76 is shown as comprising a plurality of accordion-like zig-zag structures that cause the sacrificial/elongatable/weakened region 76 to be weaker than the remaining portions of the U-shaped loop 70. Hence, when U-shaped loop 70 is subject to a sufficient force in the direction of the arrow in FIG. 6B, e.g., those forces associated with a falling person or object, sacrificial/elongatable/weakened region 76 is elongated and undergoes plastic deformation, which serves a dual purpose of absorbing and attenuating the applied forces, as well as a serving as an indicator that the force damper member 30 has been subject to a sufficient force and cannot be reused. It should be further appreciated that while FIGS. 6A and 6B depict sacrificially elongatable/weakened region 76 in the form of a plurality of accordion-like zig-zag structures, sacrificially elongatable/weakened region 76 can be configured to comprise other than accordion-like zig-zag structures and can include, for example, round or square sinusoidal or helical-type structures. Additionally, while FIGS. 6A and 6B depict a single sacrificially elongatable/weakened region associated with a single U-shaped loop, one or more such sacrificial regions 76 may be provided on a single U-shaped loop, or on more than one U-shaped loop.

Experimental Data

Drop tests using one or more various of the various system components were conducted and results of the various tests showed marked and unexpected improvements as compared to existing drop data related to known components and systems. For example, in drop tests performed using a 220 lbs mannequin and a known non-shock absorbing lanyard, which was dropped at a height of 6 ft, it was shown that the mannequin was subjected to approximately 4961 lbs. of force (See https://www.youtube.com/watch?v=k0r1r1WnvYI). In other known tests utilizing known shock absorbing lanyards and similar weights, generated forces are typically in the range of from 800-900 lbs of force. Such experimental results are typical and known in the field of fall prevention and safety.

By contrast, drop tests performed using one or more system components described above were performed and are set forth in the charts below.

Test 1:

| | | | | Other |
|---|---|---|---|---|
| | Object | Drop | Force | Perfor- |
| System Components | Weight | Height | Observed | mance |
| A.) Drawbar-type Force | 265 lbs. | 6 ft. | 603 lbs. | 14 total |
| Damper (30): | | | | inches |
| 1.) Compression Spring (80): | | | | of tear |
| 3/16 inch round Chrome | | | | tape |
| Silicon Spring Steel | | | | torn |
| Spring Rate 200 lbs/inch | | | | |
| 2.) First Loop (62) | | | | |
| round spring wire ⅛ inch | | | | |
| diameter wire | | | | |
| 3.) Second Loop w/Sacrificial/ | | | | |
| Weakened Portion (76): | | | | |
| Flat steel ⅛ thick × ½ | | | | |
| width, 7-7½ inches | | | | |
| before extension | | | | |
| 3 total square sinusoidal zig- | | | | |
| zags (each 1 inch length, ½ | | | | |
| inch width), 2 on first leg, 1 | | | | |
| on second leg | | | | |
| B. 6 ft. Tearway Lanyard (90) | | | | |
| Nylon webbing including 2, | | | | |
| 10 inch sections of 900 lbs. | | | | |
| tear tape (103). | | | | |

Test 2:

| | | | | Other |
|---|---|---|---|---|
| | Object | Drop | Force | Perfor- |
| System Components | Weight | Height | Observed | mance |
| A. Drawbar-type Force | 265 lbs. | 6 ft. | 628 lbs. | 16 total |
| Damper (30): | | | | inches |
| 1.) Compression Spring (80) | | | | of tear |
| 3/16 Round Chrome | | | | tape |
| Silicon Spring Steel | | | | torn |
| Spring Rate 200 lbs/inch | | | | |
| 2.) First Loop (62) | | | | |
| round spring wire ⅛ inch | | | | |
| diameter wire | | | | |
| 3.) Second Loop w/Sacrificial/ | | | | |
| Weakened Portion (76) | | | | |
| Flat steel ⅛ thick × ½ | | | | |
| width, 7-7½ inches | | | | |
| before extension | | | | |
| 3 total square sinusoidal zig- | | | | |
| zags (each 1 inch length, ½ | | | | |
| inch width), 2 on first leg, 1 | | | | |
| on second leg | | | | |
| B.) 6 ft. Tearway Lanyard (90) | | | | |
| Nylon webbing including 2, | | | | |
| 10 inch sections of 900 lbs. | | | | |
| tear tape (103). | | | | |

Test 3:

| | | | | Other |
|---|---|---|---|---|
| | Object | Drop | Force | Perfor- |
| System Components | Weight | Height | Observed | mance |
| A.) Drawbar-type Force | 265 lbs. | 6 ft. | 642 lbs. | 18 |
| Damper (30) | | | | inches |
| 1.) Compression Spring (80) | | | | of tear |
| 3/16 round Chrome | | | | tape |
| Silicon Spring Steel | | | | torn |
| Spring Rate 200 lbs/inch | | | | |
| 2.) First Loop (62) | | | | |
| round spring wire ⅛ inch | | | | |
| diameter wire | | | | |
| 3.) Second Loop w/Sacrificial/ | | | | |
| Weakened Portion (76) | | | | |
| Flat steel ⅛ thick × ½ | | | | |
| width, 7-7½ length inches | | | | |
| before extension | | | | |
| 2 total square sinusoidal zig- | | | | |
| zags (each 1 inch length, ½ | | | | |
| inch width), 1 at upper | | | | |
| portion of first loop leg and | | | | |
| 1 at lower portion of second | | | | |
| loop leg. | | | | |
| B.) 6 ft. Tearway Lanyard (90) | | | | |
| Nylon webbing including 2, | | | | |
| 10 inch sections of 900 lbs. | | | | |
| tear tape (103) | | | | |

Test 4:

| | | | | Other |
|---|---|---|---|---|
| | Object | Drop | Force | Perfor- |
| System Components | Weight | Height | Observed | mance |
| A.) Drawbar-type Force | 265 lbs. | 6 ft. | 570 lbs. | 26 |
| Damper (30): | | | | inches |
| 1.) Compression Spring (80) | | | | of tear |
| 3/16 round Chrome | | | | tape |
| Silicon Spring Steel | | | | torn |
| Spring Rate 200 lbs/inch | | | | |
| 2.) First Loop (62) | | | | |
| round spring wire ⅛ inch | | | | |
| diameter wire | | | | |
| 3.) Second Loop w/Sacrificial/ | | | | |
| Weakened Portion (76) | | | | |
| Flat steel ⅛ thick × ½ | | | | |
| width, 7-7½ length inches | | | | |
| before extension | | | | |
| 2 total square sinusoidal zig- | | | | |
| zags (each 1 inch length, ½ | | | | |
| inch width), 1 at upper | | | | |
| portion of first loop leg and | | | | |
| 1 at lower portion of second | | | | |
| loop leg. | | | | |
| B.) 6 ft. Tearway Lanyard (90) | | | | |
| Nylon webbing including 3 | | | | |
| sections of 900 lbs. | | | | |
| tear tape (103): | | | | |
| 1. First 6 inch section: 4 total | | | | |
| ¼ inch punch holes punched | | | | |
| on center every 1 inch. | | | | |
| 2. Second 10 inch section: No | | | | |
| punched holes | | | | |
| 3. Third 10 inch section: No | | | | |
| punched holes | | | | |

As can be appreciated from the test data above, which are exemplary only, upon the use of one or more of the system components set forth in the instant application, it is seen that vast reductions in the amount of force applied upon a falling object or person can be observed, which reductions are wholly unexpected and comprise a marked improvement as compared to existing and known components and systems. It is believed that the various system components act in conjunction with one another so as to produce a synergistic effect that is greater than the sum of the system components themselves.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### PARTS LIST

10 Force Damping System
20 Force Absorbing Harness
22 Back Strap Portion (Outer)
22A Back Strap Portion (Inner)
24 Chest/Shoulder Strap Portion (Outer)
24A Chest/Shoulder Strap Portion (Inner)
26 Belt Portion
28 Thigh Strap Portion (Outer)
28A Thigh Strap Portion (Inner)
29 Retaining/Safety Stitching
30 Elastically Deformable Member/Resilient Portion
32 Looped Safety Portion
34 D-Ring Mount
36 D-Ring Assembly Mount
37 Extension Spring Member
38 D-Ring Loop
40 D-Ring Strap Connector
42 Sacrificially Elongatable Member
43 Zig-Zag Configuration
44 Connector (Carabiner)
45 Spring Member Configuration
46 Compression Spring Member
47 Channel
48 Endpost
50 Stop
53 Bent Bar/Weakened Bar Configuration
54 Extension Spring Member
55 Wire Loop Configuration
56 Crossmember
60 Force Damper Member
62 First U-Shaped Loop
64 Closed Loop End Portion
66 Leg Portion
68 Open End U-Portion
70 Second U-Shaped Loop
72 Open End U-Portion
74 Leg Portion
76 Sacrificial/Weakened Region
78 Closed Loop End Portion
80 Compression Member
90 Tear-Away Lanyard
92 Strap Connecting Portion
94 Intermediate Strap Portion
96 Tear-Away Portion
98 Resilient Portion
100 Looped Safety Portion
102 Sacrificial Tear-Away Portion
103 Intermediate Portion
104 Looped Safety Portion
105 Free End
106 Elastically Deformable Member/Resilient Portions

What is claimed is:

1. A force damping system arranged to progressively arrest a first force imparted by an object moving in a first direction, the force damping system comprising:
a force damper member;
a tear-away lanyard, and,
a force absorbing harness;
wherein, the force damper member comprises a compression member and a sacrificially elongatable member, the compression member elastically deformable and compressible when the first force is imparted and the sacrificially elongatable member plastically deformable and elongatable when the first force is imparted;
wherein, the tear-away lanyard includes a first terminal end and a second terminal end and at least a pair of sacrificial tear-away regions disposed between the first terminal end and the second terminal end;
wherein, the force absorbing harness includes a harness connection member capable of connecting at least one of the first terminal end or the second terminal end of the tear-away lanyard, the harness connection member including a sacrificial member that is plastically deformable when the first force is imparted.

2. The force damping system of claim 1, wherein the sacrificial member of the harness connection member comprises an elongatable portion.

3. The force damping system of claim 2, wherein the elongatable portion of the harness connection member comprises one or more of a zig-zag portion, a sinusoidal portion, a helical portion, a cross member, a spring member, or a wire member.

4. The force damping system of claim 1, wherein the sacrificial member of the harness connection member comprises a compressible member.

5. The force damping system of claim 1, wherein the force damper comprises a drawbar spring including the compression member and a pair of oppositely disposed loop members, each of the loop members having a closed loop end portion and at least one leg end portion, each of the at least one leg end portions passing through the compression member, each of the at least one leg end portions having an end configured to engage with opposite ends of the compression member such that when sufficient forces are applied upon the closed loop end portions of each of the oppositely disposed loop members, the compression member is compressible.

6. The force damping system of claim 5, wherein the compression member comprises a compression spring.

7. The force damping system of claim 5, wherein the at least one leg end portion of at least one of the oppositely disposed loop members includes a weakened region that is capable of increased plastic deformation relative to the closed loop end portion thereof.

8. The force damper of claim 7, wherein the weakened region comprises one or more of a zig-zag portion, a sinusoidal portion, or a helical portion.

9. The force damping system of claim 7, wherein the each of the oppositely disposed loop members comprises a pair of leg end portions, and each leg of the pair of leg end portions of at least one of the loop members includes the sacrificially elongatable member and weakened region.

10. The force damping system of claim 9, wherein the weakened region comprises one or more of a zig-zag portion, a sinusoidal portion, or a helical portion.

11. The force damping system of claim 1, wherein a length of the tear-away lanyard is from 6-7 feet.

12. The force damping system of claim 1,
wherein each of the sacrificial tear-away regions comprise a looped safety portion in conjunction with a sacrificial tear-way portion,
wherein a length of a leg of the looped safety portion is from 0.75-1 feet, and
wherein a length of a leg of each sacrificial tear-away region is from 0.5-1 feet.

13. The force damping system of claim 1, wherein at least one of the force absorbing harness and the tear-away lanyard further comprise an elastically deformable member.

14. The force damping system of claim 1, wherein at least one of the force absorbing harness and the tear-away lanyard further comprise a looped safety portion in conjunction with an elastically deformable member that extends between ends of the looped safety portion.

15. The force damping system of claim 14, wherein the force absorbing harness includes a plurality of looped safety portions each in conjunction with a corresponding elastically deformable member, the plurality of looped safety portions disposed along webbed strapping of the force absorbing harness and at one or more of chest, back, and thigh portions thereof.

16. The force damping system of claim 6, wherein the compression spring is formed of steel having a 3/16 to ¼ inch cross-sectional diameter and a length in a non-compressed state that is from 2-6 inches.

17. The force damping system of claim 8, wherein the weakened region has a length that is from 1-4 inches in a non-elongated state.

18. The force damping system of claim 1, wherein the compression member has a spring rate from 150-350 lbs/inch.
